(19) United States
(12) Patent Application Publication
(10) Pub. No.: US 2021/0374847 A1
(43) Pub. Date: Dec. 2, 2021

(54) METHOD FOR AUTOMATING CREDIT OPERATIONS USING A PERSONAL USER DEVICE

(71) Applicant: Artashes Valeryevich Ikonomov, Moscow (RU)

(72) Inventor: Artashes Valeryevich Ikonomov, Moscow (RU)

(21) Appl. No.: 17/254,752

(22) PCT Filed: Jun. 15, 2019
(86) PCT No.: PCT/RU2019/050087

§ 371 Date: Dec. 21, 2020

(30) Foreign Application Priority Data
Jun. 20, 2018 (RU) 2018122507

(51) Int. Cl. G06Q 40/02; G06K 19/06

(52) U.S. Cl. CPC G06Q 40/025; G06K 19/06037

(57) ABSTRACT

Methods for automating credit operations in which, for each user, an initial credit parameter is formed upon accessing the communication server for the first time, additional data are obtained from multiple servers comprising relevant information about the specified user, an adjustment to the initial credit parameter is calculated, when a credit operation is requested, the current credit parameter of the first user is simultaneously transferred. The achieved technical result is that of providing the possibility of automatic processing of credit operations to enable the provision of the required amount of monetary funds and simultaneously to take the credit parameter of the user into account.

### FIELD OF THE INVENTION

This invention relates to methods intended for commercial and financial purposes, and more specifically, to methods for automating credit operations using a personal user device, which involve entering data about a required credit operation such as a required amount of monetary funds, a repayment period, and an interest rate, transferring such data to multiple personal devices of other users, and transmitting a signal confirming the credit operation of the first user. The proposed method can be used for automating and completing credit operations.

This description uses the following terms:

Credit operation—a provision of monetary funds or an equivalent thereof for a specified period of time based on certain conditions, which usually constitute an obligation to repay a greater amount of monetary funds or a greater amount of monetary equivalent.

Credit parameter—a variable corresponding to a value on a pre-selected credit operation risk scale, For example, it can range from 0 to 100, where a 0-value corresponds to “absolutely unreliable,” and a loan can be provided only if there is a collateral or secondary guarantees, and a 100-value corresponds to “absolutely reliable,” i.e., a loan can be provided without any collateral and/or secondary guarantees.

User's social rating—a variable corresponding to a value on a pre-selected scale for matching the user actions to the interests of society. For example, it can range from 0 to 100, where a 0-value corresponds to “absolutely does not account for the interests of others,” which allows to automatically increase the credit parameter, and a 100-value corresponds to “always accounts for the interests of others,” which allows to automatically decrease the credit parameter, As an option, the value of such increases and decreases can be the same. But generally, there could be an adjustment factor.

Server—an electronic device that performs service functions at the user's request, while providing access to certain resources. For the purposes of this description, a server is permanently connected to a combined network capable of transmitting data to the server from client devices. The server has the ability to process such data and transfer the processing result back to the client device.

Combined network as well as all connections between all modules and units include various topologies, configurations, and layouts of the components of the inter-network connection, configured to interconnect corporate, global, and local computer networks, and include, without limitation, any conventional wired, wireless, satellite, optical, and equivalent network technologies. Preferably, an internet is used as a combined network.

Personal user device—any form of a computing platform that connects to a network, such as a combined network, and allows interaction with application software. Typical examples of the individual client devices include, but are not limited to, stationary and portable personal computers, “smart” cell phones (smartphones), laptops, including tablets, lightweight clients, workstations, “non-smart” terminals connected with an application server, as well as various layouts and configurations thereof, i.e., both physical devices for interacting within communication systems and virtual devices realized based on the programmable computing devices and having a software interface for performing communication functions. Preferably, this is a smartphone (i.e., a cell phone that includes functions of a computer device) provided with a touch screen display, or a laptop computer, or similar devices, such as smart watches, glasses, etc. Quite often, such devices are portable in nature, which allows carrying them around.

User identification code—an alphanumeric, or graphic, or similar encoding, for example, a barcode or a QR code, which can be a unique encoded message comprising information about a person, which can be read by the electronic devices. For example, full name, date of birth, passport or other identification data, gender, registration address, title, rank, status, clearance level, etc.

Biockchain—a chain of transaction blocks, which represents a chain built from the formed transaction blocks stored in a distributed database according to certain rules, wherein each new database record is encrypted using a key partially comprising in the previous database record.

Payment instrument—any instrument used for making a payment, monetary account, virtual money, etc.

### Prior Art

Currently, there is a problem associated with free circulation of monetary funds within the country, and in those situations when a user experiences a shortage of funds, there is a credit institution, which is a system that provides monetary funds for a temporary use under the condition that such funds will be repaid in the greater amount. As a rule, this is handled by banks and pawnshops. However, there is no centralized system that would allow people to independently lend money to each other, while bypassing the intermediaries. With the advent of the Internet, distributed databases, and personal user devices, such as smartphones, it becomes possible to automate the process of temporarily lending monetary funds.

For example, a method for automating credit operations by using a personal user device is known from the prior art, which comprises;
entering data about a required credit operation through a combined network into a remote communication server using a personal device of a first user, said credit operation corresponding to a required amount of monetary funds, a repayment period, and an interest rate;
transferring such data about the required credit operation of the first user from the remote communication server to multiple personal devices of other users through the combined network;
transmitting a signal confirming the credit operation of the first user to the remote communication server from any of the personal devices of other users through the combined network;
using a remote payment server to generate signals corresponding to transferring the required monetary funds to the payment server of the first user.

See RF patent Na 2481639, published on Jan. 27, 2013.

This method is the closest to the proposed based on the technical substance and achieved technical result, and has been selected as a prototype of the proposed invention.

The disadvantage of this prototype is that there is no automation of the process that allows for the provision of the required funds, while simultaneously accounting for the user's credit parameter, since in such operations it is important to minimize the default amount.

As a matter of fact, it is easy to automatically lend monetary funds upon request, but it is necessary to also consider additional factors about the user who requested the loan, and use these data to limit the loan amount and automatically calculate the interest rate. Said state of the art does not allow accounting for such data.

### Disclosure of the Invention

Based on this original observation, the main goal of the invention is to propose a method for automating credit operations using a personal user device, which makes it possible to alleviate at least one of the above disadvantages, namely, to expand capabilities while ensuring automatic processing of credit operations, including the possibility of automatic processing of credit operations to enable the provision of the required amount of monetary funds, while simultaneously accounting for the user's credit parameter. The latter represents a technical objective of the invention.

To achieve this objective, the method further comprises the steps, during which:
for each user, an initial credit parameter is formed upon accessing the communication server for the first time, which is then entered into a credit parameter database hosted by the communication server;
additional data are obtained from multiple servers comprising relevant information about the specified user;
an adjustment to the initial credit parameter is automatically calculated by a computing module of the communication server based on the obtained data, which is then entered into the credit parameter database;
the first user's current credit parameter is transferred along with the specified data concerning the required credit operation of the first user during a step of data transmission from a remote communication server to multiple personal devices of other users via a combined network;
depending on the parameters of the required credit operation, a minimum value of the first user's credit parameter necessary for completing the requested credit operation is automatically calculated;
if the first user's credit parameter exceeds the calculated minimum value of the credit parameter, the credit operation is completed automatically, otherwise—no.

Due to such advantageous characteristics, it becomes possible to assign a credit parameter to each user. Such parameter may initially be the same for everyone, but as a result of processing additional data from multiple servers comprising relevant information about a specified user, this credit parameter changes in one direction or another. If this credit parameter increases, the conditions for granting a ban for a specified user improve (e.g., the ban amount increases and the interest rate decreases). If this credit parameter decreases—vice versa. Further on, the process of granting a ban becomes fully automated, since the minimum value of the first user's credit parameter required for completing the requested credit operation is calculated automatically, and if the first user's credit parameter exceeds the calculated minimum value of the credit parameter, the credit operation is completed automatically, otherwise—no.

The additional data from multiple servers comprising relevant information about a specified user may include data from tax authorities (e.g., whether the taxes were paid on time, and if there are any outstanding debts), utility companies (e.g., whether there are any unpaid balances), traffic violations and fines imposed by other services, data from court sites and bailiff services. In addition, it is also possible to request and process data from banks used by a specified user. And of course, the data related to the credit history of a specified user are used. If the earlier granted bans were repaid on time, the credit parameter increases, and vice versa.

The above features also have an unexpected non-technical effect, which is nevertheless very important: they motivate all users to improve their credit parameter, i.e., act in good faith.

There is also an embodiment of the invention, in which a signal about a decrease in the credit parameter of a second user in favor of a third user, and an increase in the credit parameter of the third user is sent to the computing module of the communication server using a personal device of the second user, followed by entering these changes into the users' credit parameter database.

Due to these advantageous characteristics, it becomes possible to expand the possibilities of automating credit operations using a personal user device. A non-technical context of these features consists in users helping each other.

There is yet another embodiment of the invention, in which the credit parameter database and the database of all completed credit operations are supported by a cluster of distributed servers, while data entry is performed by using a blockchain technology.

Due to these advantageous characteristics, it becomes possible to increase the resistance of the method toward unauthorized attempts to make changes to the databases, and changing the parameters of the system that implements this method. Since everything is stored on multiple spatially distributed computers and everything is securely encrypted, all changes are immediately overwritten on all computers, and it becomes impossible for someone to change the data.

There is yet another possible embodiment of the invention, in which an adjustment to the value of a pledged property, used to obtain a loan, is automatically calculated depending on the parameters of the required credit operation.

Due to these advantageous characteristics, it becomes possible to expand the possibilities of automating credit operations using a personal user device. As a matter of fact, when making a decision, it becomes possible to automatically account for an adjustment to the value of pledged property used to obtain a loan.

There is yet another embodiment of the invention, in which additional data are obtained from multiple servers comprising a relevant information about a specified user, namely, information comprising the user's social rating.

Due to these advantageous characteristics, it becomes possible to increase the accuracy of calculating the credit operation parameters using a personal user device. As a matter of fact, it becomes possible to process more data, and thus, increase the accuracy.

Finally, there is an embodiment of the invention, in which for each user a user's credit passport is created in the form of a graphic two-dimensional code, which is entered into the database of all completed credit operations. This code is automatically updated depending on the obtained data relative to the user's actions and operations. The current credit parameter of the first user is transmitted in the form of the user's credit passport, which represents a graphic two-dimensional code.

Due to these advantageous characteristics, it becomes possible to generate a graphic two-dimensional code, such as a QR-code, which is dynamic, i.e., linked to the present time, and is very convenient for transmission and processing. The users can easily exchange such QR-codes by scanning them with their personal devices, connect to the system, apply for loans, and provide loans.

The combination of the essential features of the invention is not known from the prior art as related to the methods for achieving a similar purpose. Therefore, it can be concluded that the invention meets the “novelty” criterion relative to the method. The non-obviousness of the solution and the global nature of the solved problem, which remained unsolved up until now, are indicative of the fact that the proposed solution is not obvious to a person skilled in the art. Therefore, the invention meets the “inventive step” criterion.

### BRIEF DESCRIPTION OF THE DRAWINGS

Other distinguishing features and advantages of the invention clearly follow from the description provided below without limitations for illustration purposes, while referencing the accompanying drawings, in which:

FIG. 1 shows a functional diagram of the automation of credit operations using a personal user device according to the invention;

FIG. 2 shows a functional diagram of the automation of credit operations using a personal user device based on a distributed cluster of servers according to the invention; and

FIG. 3 schematically shows the steps of the method for automating credit operations using a personal user device according to the invention.

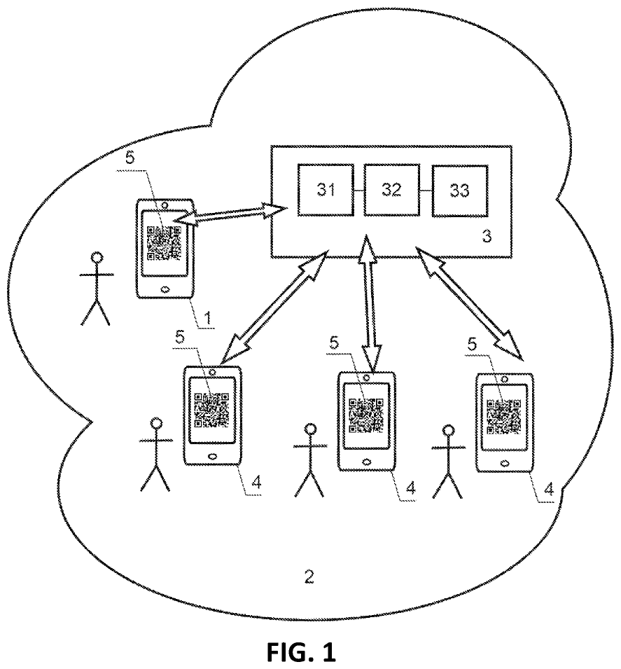

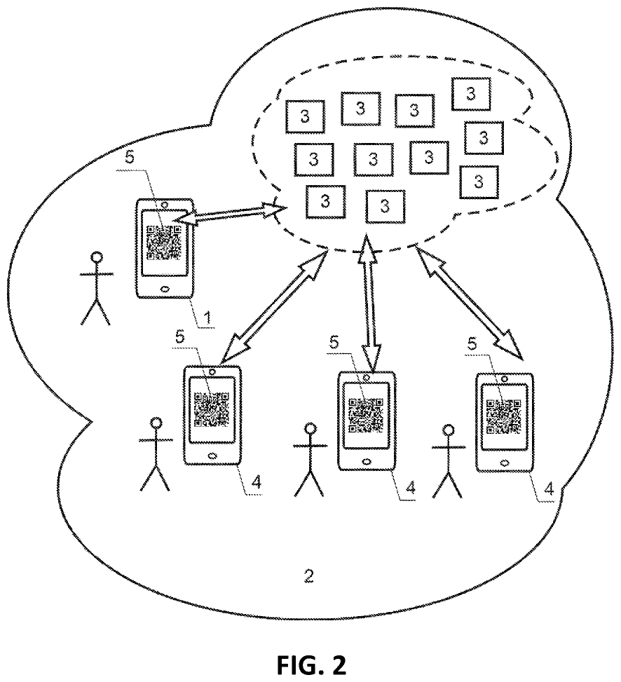

According to FIGS. 1 and 2, the implementation of this method requires a personal user device 1, which is connected via a combined network 2 to a remote communication server 3. From the server 3, it is already possible to transmit the specified data about required credit operation of the first user to a number of personal devices 4 of other users through the combined network 2.

Since for each user, an initial credit parameter is formed upon accessing the communication server 3 for the first time, this parameter is entered into a database 31 hosted by the communication server 3.

Since the data require processing, the latter is performed using a computing module 32 of the communication server, which is connected to the database 31. It is also connected to a database 33 of all completed credit operations, supported by the server

The option, when a cluster of the distributed servers is used instead of the server 3 to enter data using a blockchain technology, is shown in FIG. 2.

Figures also show a QR-code 5 of the first user, which is formed by the server 3, This code is transmitted to the screen of the user device 1, as well as the screens of devices 4 of other users.

### EMBODIMENTS OF THE INVENTION

A method for automating credit operations using a personal user device operates as follows. Provided below is the most comprehensive embodiment of the invention, keeping in mind that it does not limit the application of the invention.

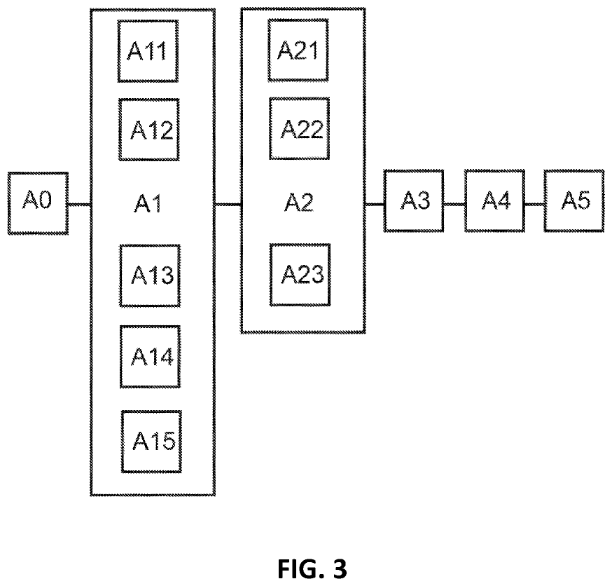

According to FIG. 3:

Stage A0. For each user, upon accessing a communication server for the first time, an initial credit parameter is formed, which is entered into a credit parameter database hosted by the communication server. The credit parameter database and a database of all completed credit operations are supported by a cluster of distributed servers. while the data are entered using a blockchain technology.

Stage A1. Supplemental data comprising relevant information about a specified user are received from multiple servers.

Stage A11. The data about the required credit operation, corresponding to a required amount of monetary funds, a repayment period, and an interest rate, are entered through a combined network to the remote communication server using a personal device of the first user.

Stage A12. Supplementary data comprising relevant information about the specified user, namely, user's social rating, is obtained from multiple servers.

Stage A13. For each user, a user's credit passport is created in the form of a graphic two-dimensional code, which is entered into the database of all completed credit operations, and which is automatically updated depending on the obtained data related to the actions and operations of the user. The first user's current credit parameter is transferred as the user's credit passport in the form of a graphic two-dimensional code.

Stage A14. A signal about a decrease in the credit parameter of the second user in favor of the third user, and an increase in the credit parameter of the third user is sent to the computing module of the communication server using a personal device of the second user, followed by entering these changes into the users' credit parameter database.

Stage A15. Based on the obtained data, an adjustment to the initial credit parameter is automatically calculated using the computing module of the communication server and entered into the credit parameter database.

Stage A2. The data about the required credit operation of the first user are transferred from the remote communication server via the combined network to multiple personal devices of other users.

Stage A21. The first user's current credit parameter is transferred along with the specified data concerning the required credit operation of the first user during a step of data transmission from the remote communication server to multiple personal devices of other users via the combined network.

Stage A22. Depending on the parameters of the required credit operation, a minimum value of the first user's credit parameter, required for completing the requested credit operation, is automatically calculated.

Stage A23. Depending on the parameters of the required credit operation, an adjustment to the value of the pledged property, used to obtain the loan, is automatically calculated.

Stage A3. A signal confirming the credit operation of the first user is transmitted to the remote communication server via the combined network from any of the personal devices of other users.

Stage A4. A remote payment server is used to generate signals corresponding to transferring the required funds to the payment server of the first user.

Stage A5. If the credit parameter of the first user exceeds the calculated minimum value of the credit parameter, the credit operation is automatically completed, otherwise—no.

The sequence of steps is approximate and allows rearranging, reducing, adding, or performing certain operations concurrently without losing the ability to automate credit operations using the personal user device.

### EXAMPLE 1

Each user is assigned the same credit parameter at birth. For example, 100 points (arbitrarily). Every year, this parameter increases automatically. In case of a violation of the established rules, for example, a traffic violation, the credit rating is automatically reduced. Upon reaching the retirement age, the accumulated amount of credit parameter points can be exchanged for fiat money or cryptocurrency. Or, the accumulated amount of credit parameter points can be partially gifted to the heirs.

### EXAMPLE 2

For each user, a user's credit passport is created in the form of a graphic two-dimensional code, such as a QR-code, which is entered into the database of all completed credit operations. All these QR-codes along with loan requirements are placed on a single site for requesting a loan. For example, if a user wants to get 100,000 rubles, he/she places a QR-code on a car that costs 300,000 rubles, and places his/her current rating QR-code (indicating the minutes of when this QR-code was obtained).

Potential lenders will make him/her offers with different conditions. Depending on such offers, e.g., different interest rates, the user who placed a loan request on the site selects the most convenient option and concludes the transaction through a smart contract system, where a temporary reassignment of the property to the lender can be notated, or if no collateral was required based purely on the user's rating QR-code.

### EXAMPLE 3

A user-borrower can simultaneously apply for a loan through a remote communication server via a combined network to multiple personal devices of other users-lenders. The lender makes the final decision regardless of the calculated minimum or maximum, as well as the social rating, and offers his/her loan option (based on his/her own terms). If the user-borrower agrees, a smart contract is automatically generated and signed in real time, and is converted into a transaction passport with a corresponding QR-code. Further on, everything is automatically transferred for registration through the blockchain system to a cluster of distributed servers and, for example, to the authorized registration authorities of the country, region, city, etc.

### INDUSTRIAL APPLICABILITY

The proposed method of automating credit operations using a personal user device can be practically implemented by a skilled person. Once implemented, the method ensures the realization of the claimed purpose, which makes it possible to conclude that the invention meets the “industrial applicability” criterion.

In accordance with the proposed invention, a pilot system for automating credit operations using a personal user device was realized, i.e., servers specifically configured to process all data were tested.

Testing of the pilot system has shown that it provides the ability to:
automatically calculate the initial credit parameter of each user;
automatically adjust the credit parameter of each user;
automatically calculate the conditions for granting a loan, repayment period, interest rate, and possibly, a collateral value, when one user requests the required amount; and
automatically complete the transfer of funds upon approval of the request by any second user.

Thus, the objective of the invention—to expand capabilities while ensuring automatic processing of credit operations, including the possibility of automatic processing of credit operations to enable the provision of the required amount of monetary funds, while simultaneously accounting for the user's credit parameter—was achieved.

An additional useful technical result of the proposed invention is that:
when using a blockchain technology, this method provides an additional possibility to create a smart contract in case of a mutual user lending, where both secured and unsecured loans are used based on the credit parameters of the users;
this method allows for creating an independent decentralized environment for conducting credit operations, which consists of the physical persons (although, not necessarily).

An additional useful non-technical result of the proposed invention is that:
this method makes it possible to increase the responsibility of the population for their actions, since any action that reduces the credit parameter becomes disadvantageous.

1. Method for automating credit operations using a personal user device, wherein method comprises:
entering data about a required credit operation through a combined network into a remote communication server using a personal device of a first user, the credit operation corresponding to a required amount of monetary funds, a repayment period, and an interest rate,
transferring such data about the required credit operation of the first user from the remote communication server to multiple personal devices of other users through the combined network;
transmitting a signal confirming the credit operation of the first user to the remote communication server from any of the personal devices of other users through the combined network;
using a remote payment server to generate signals corresponding to transferring the required amount of monetary funds to a payment server of the first user, wherein the method further comprises:
for each user, an initial credit parameter is formed upon accessing the communication server for the first time, which is then entered into a credit parameter database hosted by the communication server;
additional data are obtained from multiple servers comprising relevant information about the specified user;
an adjustment to the initial credit parameter is automatically calculated by a computing module of the communication server based on the obtained data, which is then entered into the credit parameter database;
the first user's current credit parameter is transferred along with the specified data concerning the required credit operation of the first user during a step of data transmission from the remote communication server to the multiple personal devices of other users via the combined network;
depending on the parameters of the required credit operation, a minimum value of the first user's credit parameter necessary for completing the requested credit operation is automatically calculated;
if the first user's credit parameter exceeds the calculated minimum value of the credit parameter, the credit operation is completed automatically, otherwise the credit operation is not completed.

2. Method according to claim 1, wherein a signal about a decrease in the credit parameter of a second user in favor of a third user, and an increase in the credit parameter of the third user is sent to the computing module of the communication server using a personal device of the second user, followed by entering these changes into the users' credit parameter database.

3. Method according to claim 1, wherein the credit parameter database and the database of all completed credit operations are supported by a cluster of distributed servers, while data entry is performed by using a blockchain technology.

4. Method according to claim 1, wherein an adjustment to the value of a pledged property, used to obtain a loan, is automatically calculated depending on the parameters of the required credit operation.

5. Method according to claim 1, wherein additional data are obtained from multiple servers comprising a relevant information about a specified user, wherein the additional data include information comprising the user's social rating.

6. Method according to claim 1, wherein for each user a user's credit passport is created in the form of a graphic two-dimensional code, which is entered into the database of all completed credit operations, and which is automatically updated depending on the obtained data relative to the user's actions and operations, and wherein the current credit parameter of the first user is transmitted in the form of the user's credit passport, which represents a graphic two-dimensional code.
